(19) United States
(12) Patent Application Publication
(10) Pub. No.: US 2026/0111031 A1
(43) Pub. Date: Apr. 23, 2026

(54) Automatic Centering of Drone Flight Controllers Using a Fine-Step Trim Controller

(71) Applicant: Umaid Imran, Toronto (CA)

(72) Inventor: Umaid Imran, Toronto (CA)

(21) Appl. No.: 18/918,388

(22) Filed: Oct. 17, 2024

(51) Int. Cl. G05D 1/495; B64U 10/25; G05D 109/22

(52) U.S. Cl. CPC G05D 1/495; B64U 10/25; B64U 2201/20; G05D 2109/22

(57) ABSTRACT

A fine-step trim controller operating within a flight control system is configured to receive PID value data and sensory data and, based on those values, incrementally and decrementally adjust PID (Proportional-Integral-Derivative) coefficient values to center the drone during flight. The fine-step trim controller periodically and continuously adjusts the PID coefficient values, ultimately affecting the PID values implemented by a PID flight controller that manages the flight control servos. The PID flight controller and fine-step trim controller collaborate and are in continuous and cyclic communication to center the drone. As the drone continues its navigation to a given destination, the flight control system works to ensure the drone flies smoothly by managing its maneuvers with stability.

### BACKGROUND

Fixed-wing drones, perform various navigation and maneuvering to maintain flight and arrive at a desired destination. During flight, drones require constant execution of a control system to maintain stable flight.

### SUMMARY

A fine-step trim controller operating within a flight control system is configured to receive PID output data and sensory data and, based on those values, incrementally and decrementally adjust PID (Proportional-Integral-Derivative) coefficient values to center the PID controller for more stabilized flight of the drone. The fine-step trim controller periodically and continuously adjusts the PID coefficient values, ultimately affecting the PID outputs, which manage the flight control servos. The PID flight controller and fine-step trim controller collaborate in continuous and cyclic communication to center the drone. As the drone continues its navigation to a given destination, the flight control system works to ensure the drone flies smoothly by managing its attitude during all stages of flight.

### BRIEF DESCRIPTION OF THE DRAWINGS

FIG. 1 shows an illustrative environment of a user controlling a drone's movements and activities with a remote control;

FIG. 2 shows an illustrative diagram showing a drone's components;

FIG. 3 shows an illustrative representation of the drone traveling from an origin to a desired destination;

FIGS. 4A-D show illustrative representations of the drone's center of gravity tilted during flight to its destination;

FIG. 5 shows an illustrative schematic diagram of a fine step controller adjusting the drone's body during flight;

FIG. 6 shows an illustrative schematic diagram of the PID flight controller adjusting the drone's PID coefficients to reach center during flight;

FIG. 7 shows an illustrative flowchart implemented by a computing device, such as one or more of the user's remote control or the drone; and

FIG. 8 shows a simplified block diagram of a computing device that may be used to implement the present automatic centering of drones using a fine-step trim controller.

Like reference numerals indicate like elements in the drawings. Elements are not drawn to scale unless otherwise indicated.

### DETAILED DESCRIPTION

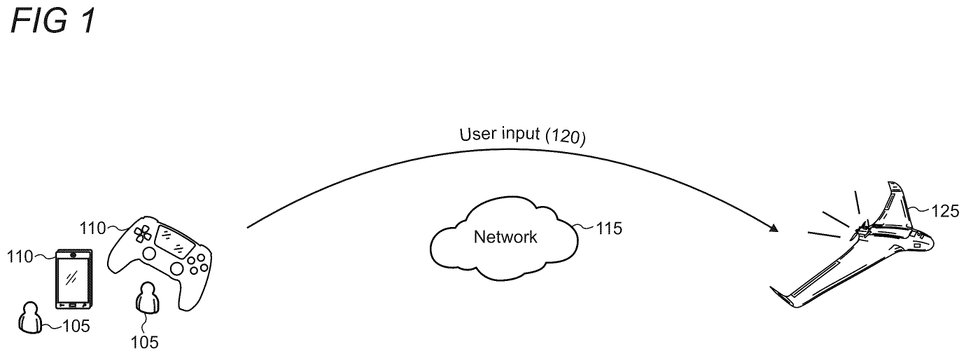

FIG. 1 shows an illustrative environment where a user 105 uses a remote control 110 to control and maneuver a drone 125 or unmanned aerial vehicle (UAV). In this illustrative example, the drone is a fixed-wing drone, but other implementations may also leverage the system and disclosure described herein. While a dedicated drone remote control may be used, in some scenarios, the remote control may be the user's smartphone or other computing device that, for example, has an application to control the drone. Any user input 120 from the remote control 110 may be transmitted to the drone 125 over a network 115, which may include any one or more of a cellular connection (e.g., 6G, 5G, LTE, etc.), a wide area network, a local area network, a personal area network, Bluetooth®, NFC (near field communication), or any combination thereof.

In some implementations, the user's remote control 110 may come with a display screen that receives image data, such as video or images, from the drone's vision system, which can include a camera, LIDAR (light detection and ranging), or other onboard vision system. The user's input 120 can include individual directional movements or other maneuvers from the user, such as left and right or altitude changes. Alternatively, the user may direct the drone to a particular location, such as a pin on a map, longitude/latitude data, etc.

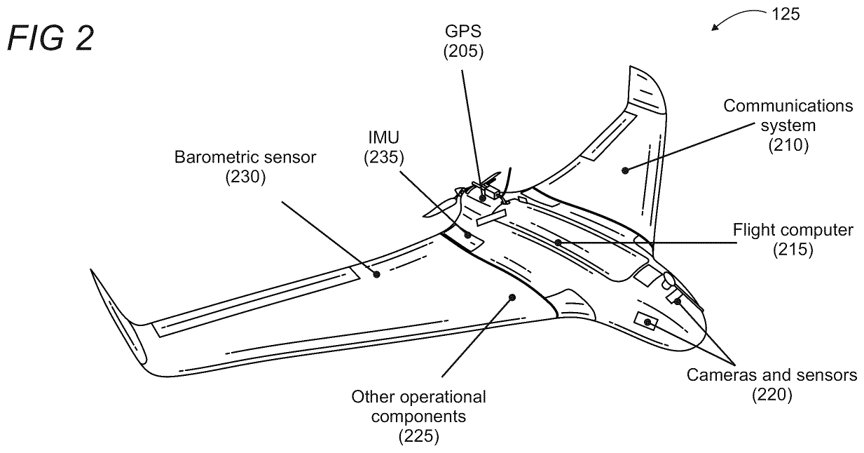

FIG. 2 shows an illustrative representation in which the drone 125 includes a series of operational components that effectuate its capabilities. While some components are shown in FIG. 2, the descriptions are exemplary only and non-exhaustive, and in other drones, certain components shown may not be present. The GPS (global positioning system) 205 can be a satellite-based navigation system that provides location, navigation, and timing (PNT) services globally. It consists of a constellation of satellites, ground control stations, and user equipment that work together to determine precise locations on Earth. The communications system 210 enables the drone to exchange data with its operator and other systems, and can include radio frequency (RF) transmitters and receivers to send and receive signals for control, telemetry, and data transmission, antennas, and a data link.

The flight computer can include one or more processors, memory devices, a printed circuit board (PCB), and other components that help the drone operate. It can also include a flight control system that processes sensory data and pilot/user inputs to control the drone's motors and maintain flight stability and navigation. The flight computer may control navigation, integrate sensory data for processing, and implement failsafe mechanisms for safety features, among other functions.

The drone 125 can include various cameras and sensors 220, such as the barometric sensor 230, IMU (inertial measurement unit) 235, among other sensors. The barometric sensor measures atmospheric pressure to determine the drone's altitude. Such barometric data can be used to measure altitude, maintain a stable altitude during flight, and calculate vertical speed. The IMU 235 is typically used for flight control, such as attitude determination for orientation and tilt angles for a stable flight and positioning, acceleration measurement, angular velocity measurement, magnetic field measurement, and autonomous navigation, among other possible functions. Other types of sensors are also possible, such as LIDAR, radar, etc. Other operational components 225 not shown and described may also be used by the drone.

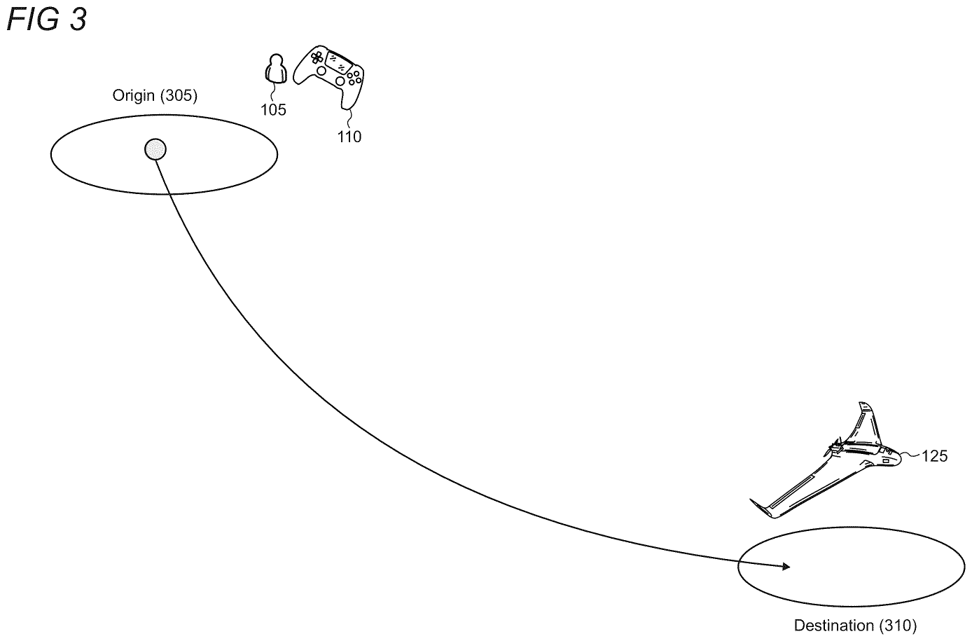

FIG. 3 shows an illustrative representation in which the drone 125 initiates at an origin 305 and reaches a destination 310. The user 105 controls the drone's travel using their control 110. During the flight, the drone not only travels in various directions to arrive at the destination but also has to manage its flight stability to arrive at the destination successfully and efficiently.

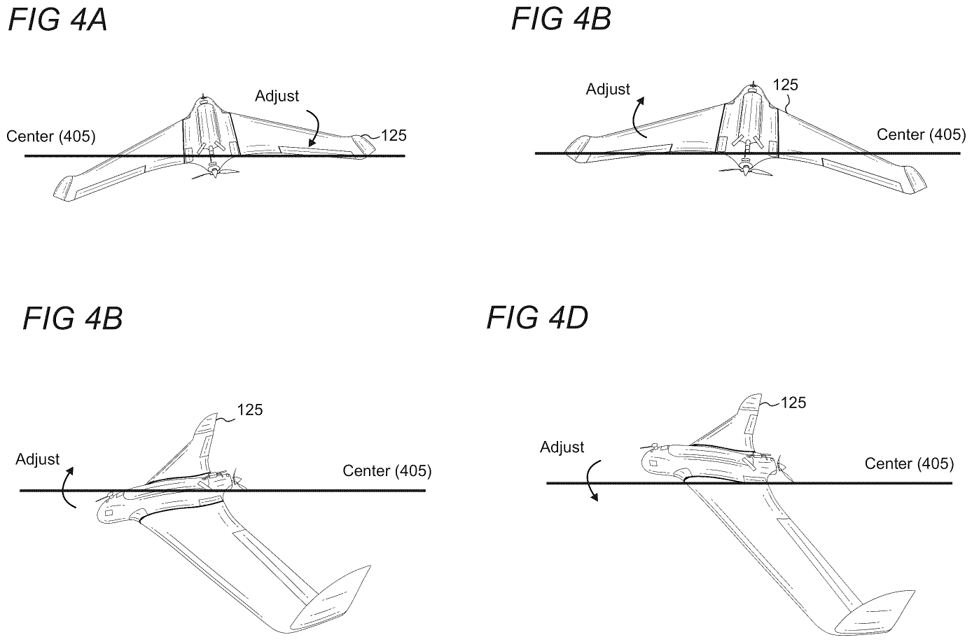

FIGS. 4A-4D show illustrative representations in which the drone 125 can become off-centered during flight to a destination 310. FIG. 4A, for example, shows the drone's left tilt relative to its center 405. FIG. 4B likewise shows a right tilt, which can occur during flight. FIGS. 4C and 4D show forward and back tilts of the drone 125 that make the aircraft of-centered. All of these off-centered tilts can be addressed by the system described herein, among other off-centered actions, as FIGS. 4A-D are exemplary only.

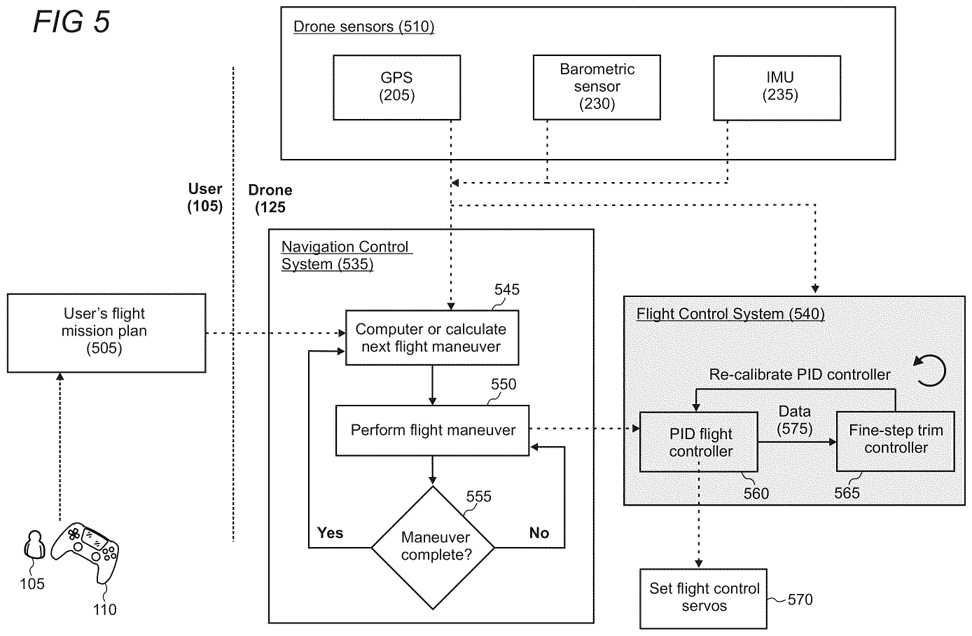

FIG. 5 shows an illustrative schematic representation in which the drone's flight control system includes a fine-step trim controller 565 that centers the drone 125 during flight. Center, in this regard, means leveling the drone's tilt to a level flight surface to ensure accurate flight. Initially, the user 105, using the remote control 110, inputs a flight mission plan 505 that the drone receives. This can include more precise individual drone movements or a locational directive to which the drone is directed. The flight mission plan 505 is received and used by the drone's navigation control system 535 to determine the drone's maneuvers to arrive at the desired destination. The drone's sensors 505, which can include the various sensors described with respect to FIG. 2, gather various data sensory data and transmit such sensory data to various drone systems, such as the navigation control system 535 and flight control system 540. These various drone systems may be part of the flight computer 215 (FIG. 2).

For example, the navigation control system 535 calculates a next flight maneuver 545 based on the flight mission plan 505. So, calculating the next flight maneuver can include changing its attitude, altitude, throttle, etc. Next, at step 550, the drone performs the flight maneuver previously determined and calibrated at step 545. A determination is performed on whether the flight maneuver is complete at step 555, and if not, then the step reverts to performing the maneuver at step 550. When the maneuver is complete, the process repeats itself and calculates the next flight maneuver at step 545. The navigation control system 535 continuously operates as such to direct the drone to an intended destination.

While the navigation control system 535 controls the drone's navigational and directional movements, the flight control system 540 manages the flight stability specific operations. It ensures a stable, controlled flight, such as by ensuring that the drone is centered in achieving its navigational movements. The flight control system utilizes a PID (Proportional Integral Derivative) flight controller 560 to help stabilize and control the drone's flight. The PID controller processes data from the sensors 510 to determine the drone's orientation, altitude and movement and then calculates the appropriate servo outputs to achieve the desired flight behavior. The PID controller may manage control loops such as roll (left/right tilt), pitch (forward/back tilt), and yaw (rotation around vertical axis).

The fine-step trim controller 565 recalibrates the PID flight controller 560 periodically and continuously to center the drone 125. The fine-step trim controller makes step-size increments and decrements to the PID equation coefficients, to achieve the centered position, which is constantly shared with the PID flight controller for adjusted implementation. The PID flight controller 560 transmits updated data 575 about the PID coefficients, which is then analyzed and processed by the fine-step trim controller experimentally.

For example, in the equation Y=C₀XP+C₁XI+C₂XD+C₃, where Y is the three-dimensional output of the drone, and C₀XP, C₁XI, and C₂XD represent proportion, integral, and derivative elements (PID), respectively. The system is considered stable when ΔX=X′−X=0, where X (can be XP, XD or DI, is a three-dimensional vector) is the ideal flight attitude for a given maneuver being performed, and X′ is the actual flight attitude, hence ΔX is the difference. The fine-step trim controller 565 experimentally and incrementally adjusts the coefficients C₀, C₁, and C₂, affecting the P, I, and D coefficients as well as the additional fixed coefficient, C₃. These step-size increments may increase or decrease the coefficients by one or two in typical implementations. However, in other implementations, the step-size increments may be greater, such as three, four, etc. After each increment or decrement of the coefficients, the change is transmitted to the PID flight controller 560 to effectuate this change, which is then transmitted to the drone's servos for operation; that is, at step 570, the flight control servos are set. The servomotors can control and affect the drone's flight surfaces and throttle. The process of the PID flight controller transmitting current proportional-incremental-derivative data 575 to the fine-step trim controller for further coefficient adjustments repeats itself throughout the drone's flight. Thus, while the drone utilizes the navigation control system 535 to fly to a specific destination, the flight control system 540 simultaneously manages the drone's servos for stable flight.

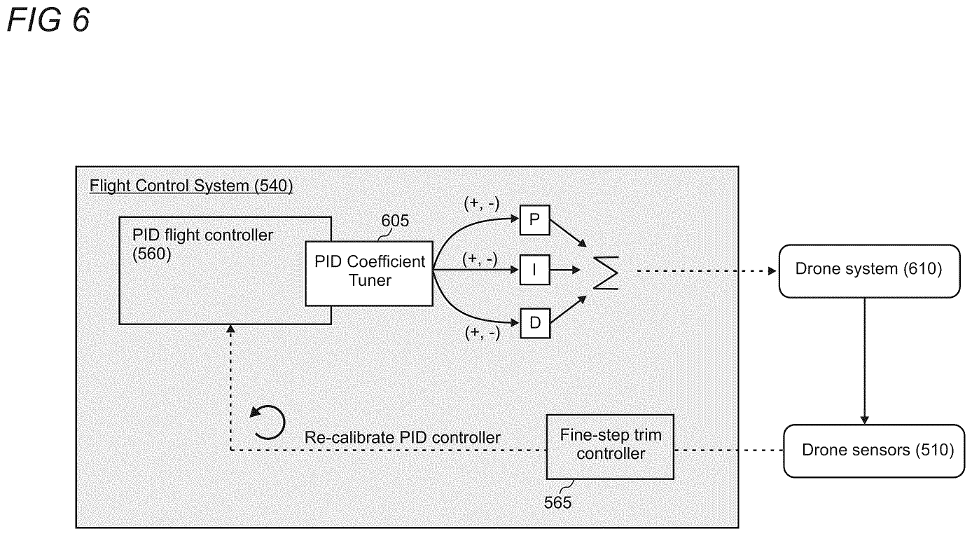

FIG. 6 shows an illustrative schematic diagram in which the specific implementation is shown with more specific detail relative to FIG. 5. The drone system 610 can be any number of proprietary or off-the-shelf systems implemented for the drone 125. Thus, the present fine-step trim controller 565 and the overall system discussed herein can be applied to any system that utilizes a PID flight controller 560 or otherwise utilizes proportional-integral-derivative control during flight.

The sensors 510 (FIG. 5) gather necessary data about the drone, its environment, flight characteristics, etc. Such sensors are utilized by the fine-step trim controller 565, along with the updated PID data 575 (FIG. 5) for experimental processing. The fine-step trim controller may adjust one or more PID coefficients, which are then transmitted to the PID flight controller 560 for re-calibration, via the PID coefficient tuner 605. The PID coefficient tuner is utilized to take the received adjustment from the fine-step trim controller for each PID coefficient value and gradually modify the PID coefficients in real-time. Updated coefficients affect the specific PID control result, which the drone's servos implement for appropriate dampening of the system. As shown in FIG. 6, the coefficients are positively or negatively adjusted.

As the process continues to repeat itself periodically, the fine-step trim controller 565 determines whether a specific change was sufficient, insufficient, needs to change direction, etc. For example, relying on the sensor data, which is picked up in real-time, the fine-step trim controller determines whether the drone 125 is centered or tilted about a three-dimensional axis. Such data lets the fine-step trim controller know in which direction to adjust the PID coefficients to adjust the servos. Thus, the fine-step trim controller simultaneously leverages its current knowledge of the PID values, as received from the PID flight controller 560 (FIG. 5), and the sensory data to determine how effective the current PID controller coefficients are, and whether to increment or decrement them. As these values are continuously adjusted, the process continues to repeat until the drone lands safely.

In one example, while the drone is traveling the PID controller and fine-step trim controller are running off their default coefficients, which can be relatively aggressive, or under-damped. The PID controller would cause the drone to oscillate in an under-damped, uncentred manner and the fine-step trim controller would make step size increments/decrements via C₃. The fine step trim controller is sampling and analyzing ΔX values at all times. Once ΔX values are seen to oscillate symmetrically, meaning the drone is “centered”, C₃ is kept fixed. At this point, the drone is able to fly itself but is likely still flying underdamped. If the rate of oscillations is higher than an acceptable threshold, then C₂ is adjusted in a finite step via the fine-step trim controller. If the swing of the oscillations is higher than an acceptable threshold, then C₀ is adjusted in a finite step via the fine-step trim controller. If the oscillations are slow and develop a bias in one direction or another, then C₁ is adjusted to compensate.

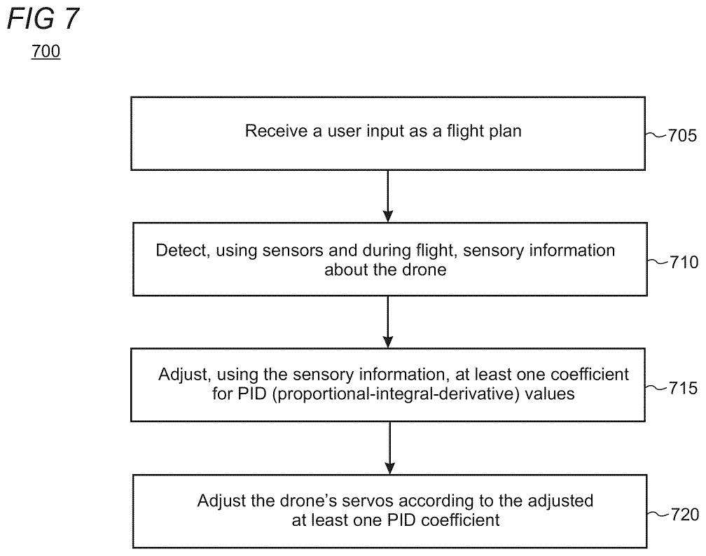

FIG. 7 shows an illustrative flowchart 700 that may be implemented by at least one of a drone, a computing device, the drone controller, or a combination thereof. In step 705, the drone receives a user input as a flight plan. The flight plan may include, for example, a specific destination for the drone to autonomously navigate to or may include specific user directional movements entered on their remote control, smartphone, etc., such as left, right, diagonal, up, down, and the like. In step 710, the drone detects sensory information about the drone using sensors and during flight. The sensors may be onboard, such as a barometer, inertial measurement unit, GPS (global positioning system), etc. In step 715, the drone adjusts, using the sensory information, at least one coefficient for PID (proportional-integral-derivative) values. The coefficients affect the specific P, I, or D value, so adjusting the coefficient thereby adjusts the ultimate response of the PID controller. Values are incrementally or decrementally adjusted experimentally to center the drone. A fine-step trim controller continuously and periodically receives the sensory data and PID values, from a dedicated PID flight controller, to experimentally adjust the PID values. In step 720, the drone adjusts the drone's servos according to the adjusted at least one PID coefficient.

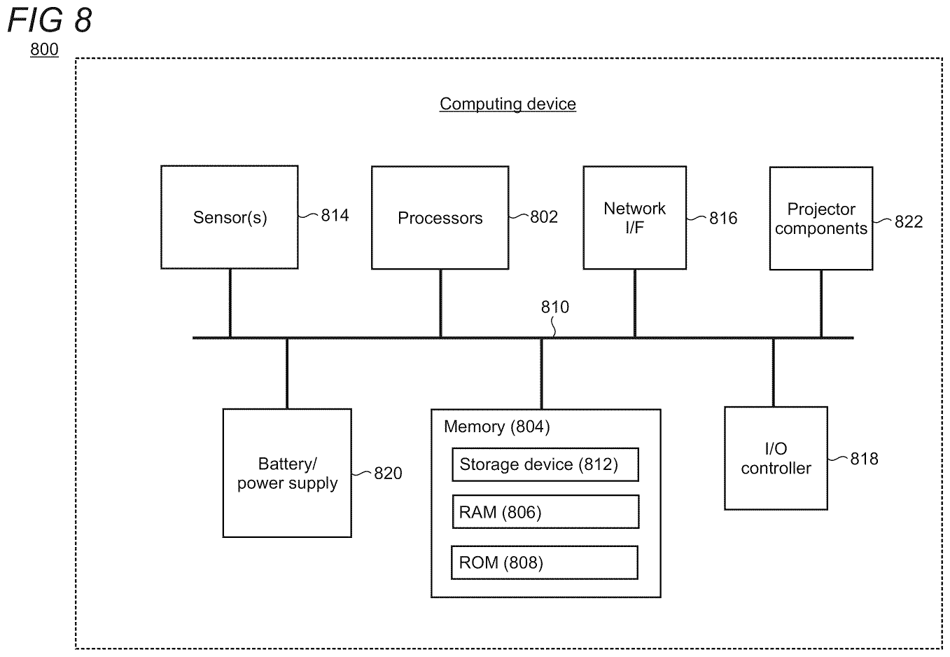

FIG. 8 shows an illustrative architecture 800 for a computing device capable of executing the various features described herein, such as a drone, remote control, or other device. The architecture 800 illustrated in FIG. 8 includes one or more processors 802 (e.g., central processing unit, dedicated AI chip, graphics processing unit, etc.), a system memory 804, including RAM (random access memory) 806, ROM (read-only memory) 808, and long-term storage devices 812. The system bus 810 operatively and functionally couples the components in the architecture 800. A basic input/output system containing the basic routines that help to transfer information between elements within the architecture 800, such as during start-up, is typically stored in the ROM 808. The architecture 800 further includes a long-term storage device 812 for storing software code or other computer-executed code that is utilized to implement applications, the file system, and the operating system. The storage device 812 is connected to processor 802 through a storage controller (not shown) connected to bus 810. The storage device 812 and its associated computer-readable storage media provide non-volatile storage for the architecture 800. Although the description of computer-readable storage media contained herein refers to a long-term storage device, such as a hard disk or CD-ROM drive, it may be appreciated by those skilled in the art that computer-readable storage media can be any available storage media that can be accessed by the architecture 800, including solid-state drives and flash memory. The computing device utilizes a battery or power supply 820 that powers up the device. The battery may be a rechargeable battery, such as a lithium-ion battery.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 800.

According to various embodiments, the architecture 800 may operate in a networked environment using logical connections to remote computers through a network. The architecture 800 may connect to the network through a network interface unit 816 connected to the bus 810. It may be appreciated that the network interface unit 816 may also be utilized to connect to other types of networks and remote computer systems. The architecture 800 also may include an input/output controller 818 for receiving and processing input from a number of other devices, including a keyboard, mouse, touchpad, touchscreen, control devices such as buttons and switches or electronic stylus (not shown in FIG. 8). Similarly, the input/output controller 818 may provide output to a display screen, user interface, a printer, or other type of output device (also not shown in FIG. 8).

It may be appreciated that any software components described herein may, when loaded into the processor 802 and executed, transform the processor 802 and the overall architecture 800 from a general-purpose computing system into a special-purpose computing system customized to facilitate the functionality presented herein. The processor 802 may be constructed from any number of transistors or other discrete circuit elements, which may individually or collectively assume any number of states. More specifically, the processor 802 may operate as a finite-state machine, in response to executable instructions contained within the software modules disclosed herein. These computer-executable instructions may transform the processor 802 by specifying how the processor 802 transitions between states, thereby transforming the transistors or other discrete hardware elements constituting the processor 802.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in architecture 800 in order to store and execute the software components presented herein. It also may be appreciated that the architecture 800 may include other types of computing devices, including wearable devices, handheld computers, embedded computer systems, smartphones, PDAs, and other types of computing devices known to those skilled in the art. It is also contemplated that the architecture 800 may not include all of the components shown in FIG. 8, may include other components that are not explicitly shown in FIG. 8, or may utilize an architecture completely different from that shown in FIG. 8. The one or more sensors 814 can include any number of sensors that enable a plunger lift to pick up data about plunger lift operations. These include the sensors, for example, shown and described in FIG. 4.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

1. A drone, comprising:
one or more sensors;
one or more processors; and
one or more hardware-based memory devices having instructions which, when executed by the one or more processors, cause the drone to:
receive a user input as a flight plan;
repeatedly perform the following steps:
detect, using sensors and during flight, sensory information about the drone;
transmit the sensory information to a fine-step trim controller;
adjust, at the fine-step trim controller and using the received sensory information, at least one coefficient for PID (proportional-integral-derivative) values, wherein the adjustment includes performing a step-size increment or decrement to the at least one coefficient, in which the step-size increment or decrement is constant by a value of one or two;
transmit, from the fine-step trim controller, the step-size increment or decrement of the at least one coefficient to a PID flight controller; and
adjust, at the PID flight controller, the drone's servos according to the adjusted the at least one coefficient for PID values.

2. The drone of claim 1, wherein the one or more processors are configured to periodically and continuously receive PID data values from a PID flight controller.

3-5. (canceled)

6. The drone of claim 1, wherein the one or more sensors includes an inertial measurement unit (IMU).

7. The drone of claim 1, wherein the one or more sensors include a barometric sensor.

8. One or more hardware-based non-transitory computer-readable memory devices storing computer-executable instructions which, when executed by one or more processors disposed in a drone, causes the drone to:
receive a user input as a flight plan;
repeatedly perform the following steps:
detect, using sensors and during flight, sensory information about the drone;
transmit the sensory information to a fine-step trim controller;
receive the detected sensory information at the fine-step trim controller;
adjust, at the fine-step trim controller and using the received sensory information, at least one coefficient for PID (proportional-integral-derivative) values, wherein the adjustment includes performing a step-size increment or decrement to the at least one coefficient, in which the step-size increment or decrement is constant by a value of one or two;
transmit, from the fine-step trim controller, the step-size increment or decrement of the at least one coefficient to a PID flight controller; and
adjust, at the PID flight controller, the drone's servos according to the adjusted the at least one coefficient for PID values.

9. The one or more hardware-based non-transitory computer-readable memory devices of claim 8, wherein the one or more processors are configured to periodically and continuously receive PID data values from a PID flight controller.

10-12. (canceled)

13. The one or more hardware-based non-transitory computer-readable memory devices of claim 8, wherein the one or more sensors includes an inertial measurement unit (IMU).

14. The one or more hardware-based non-transitory computer-readable memory devices of claim 8, wherein the one or more sensors include a barometric sensor.
